(19) United States
(12) Patent Application Publication
(10) Pub. No.: US 2012/0158511 A1
(43) Pub. Date: Jun. 21, 2012

(54) PROVISION OF CONTEXTUAL ADVERTISING

(75) Inventors: Mike Lucero, Bellevue, WA (US); Charlie Heinemann, Redmond, WA (US); Kevin Gammill, Beaux Arts, WA (US); Paolo Malabuyo, Kirkland, WA (US); Stacey Law, Redmond, WA (US)

(73) Assignee: MICROSOFT CORPORATION, Redmond, WA (US)

(21) Appl. No.: 12/975,107

(22) Filed: Dec. 21, 2010

(51) Int. Cl. G06Q 30/00

(52) U.S. Cl. 705/14.64; 705/14.49

(57) ABSTRACT

Embodiments related to the provision of advertising in an electronic media environment are disclosed. For example, one embodiment provides, on a computing device including a media player and an advertising layer configured to display advertising information related to media played via the media player, a method of presenting advertising content for media. The method includes receiving an input requesting playback of a media content item, sending a request for the media content item to a media server, receiving the media content item from the media server, and receiving advertising layer information from the media server. The method further comprises associating trigger points in the advertising layer information with the media content item, playing the media content item, and upon reaching a selected trigger point during playback of the media content item, triggering display of a notification to notify the user of available advertising content.

### BACKGROUND

With conventional linear media, including but not limited to television shows, movies, music (including music videos), etc., when a user sees or hears about an object of interest while consuming the media, such as a particular car, clothing, accessory, etc., the media offers the user no mechanism to discover additional information about the object. More recently, various network media providers have begun to offer hypervideo content that allow a user to interact with an intra-video object to bring up information on the object. Such hypervideo links may often be linked to a specific file or page such that the same content is accessed each time users interact with the intra-video object.

### SUMMARY

Accordingly, various embodiments related to the provision of contextual advertising in an electronic media environment are disclosed. For example, one embodiment provides, on a computing device comprising a media player and an advertising layer configured to display advertising information related to media played via the media player, a method of presenting advertising content for media. The method comprises receiving an input requesting playback of a media content item, sending a request for the media content item to a media server, receiving the media content item from the media server, and receiving advertising layer information from the media server. The method further comprises associating trigger points in the advertising layer information with the media content item, playing the media content item, and upon reaching a selected trigger point during playback of the media content item, triggering display of a notification to notify the user of available advertising content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example embodiment of a media and advertising provision and consumption environment.

FIG. 2 shows a flow diagram depicting an embodiment of a method for providing advertising content during playback of a media content item.

FIG. 3 shows a schematic illustration of a media content item timeline and an advertising layer timeline.

FIG. 4 shows a schematic depiction of an embodiment of a client device displaying advertising layer information.

FIG. 5 shows a schematic depiction of an embodiment of the display of advertising layer information in an example multi-user, multi-client environment.

### DETAILED DESCRIPTION

In order to provide a mechanism for discovery of additional information in connection with objects of interest in video and/or audio media content, embodiments are disclosed herein that related to the provision of contextual, advertising in an electronic media environment via an advertising layer for a media player. As will be described in more detail below, the disclosed embodiments allow a user to easily discover and interact with advertising content relevant to the context of a media content item being consumed by the user. The term “advertising layer” as used herein signifies a program executable by a client computing device along with a media player to obtain and present advertising content while the media player is currently playing, thereby allowing the presentation of the advertising content without interrupting the primary media consumption experience.

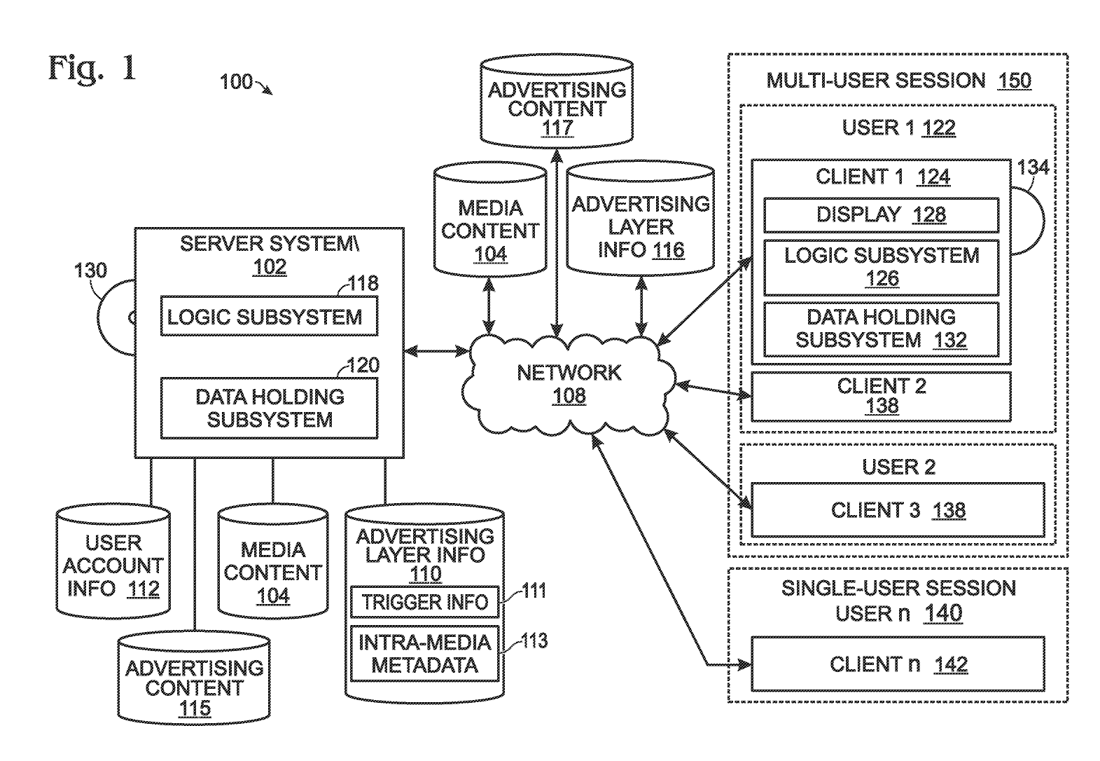

Prior to describing these embodiments, an example media and advertising provision environment 100 is described with reference to FIG. 1. Environment 100 comprises a media content server system 102, which may comprise one or more physical server computing devices, data storage devices, etc. Media content server system 102 is configured to provide streaming and/or downloadable media content 104, such as live content, recorded videos, video games, and/or audio content, to client devices 106, illustrated as an arbitrary number of client devices, via a network 108.

Media content server system 102 comprises, or otherwise is configured to access, media content 104 and advertising layer information 110 for provision to client devices 106. Media content server system 102 further comprises user account information 112 configured to allow one or more users to log onto media content server system 102 and interact with media content server system 102 in an authenticated session. In this manner, user account information, such as demographic information, interests, past media consumption history, etc. may be accessed and used to search for targeted advertising.

As described in more detail below, advertising layer information 110 may comprise a list of trigger points 111 corresponding to intra-media objects in a media content item. Further, advertising layer information 110 comprises intra-media metadata 113 associated with each trigger point 111, and also advertising content 115. Such advertising layer information may be provided to a client along with a requested media content item. Then, during playback of the requested media content item, when a trigger point is reached, relevant advertising content information may be obtained and presented to a user in an interactive manner.

In FIG. 1, advertising layer information 110 is depicted as being stored separately from media content 104, but it will be understood that the advertising layer information may be stored in either the same or different database than the associated media content item. It further will be understood that media content items and/or advertising layer information also may be stored in remote locations accessible by media content server system 102 via network 108, as is shown in FIG. 1 as media content 114 and advertising layer information 116, and advertising content 117.

It is to be understood that virtually any computer architecture may be used for media content server system 102 without departing from the scope of this disclosure. Further, media content server system 102 may comprise any other suitable components other than those depicted in FIG. 1, including but not limited to user input devices such as keyboards, mice, game controllers, cameras, microphones, displays, and/or touch screens, for example.

Logic subsystem 118 is configured to execute instructions stored in a data-holding subsystem 120 to provide the media content items, corresponding advertising layer information, and advertising content to requesting client devices 106. Logic subsystem 118 may include one or more physical devices configured to execute one or more instructions. For example, logic subsystem 118 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 118 may include one or more processors that are configured to execute software instructions. Additionally or alternatively, logic subsystem 118 may include one or more hardware or firmware logic machines configured to execute hardware or firmware instructions. Processors of logic subsystem 118 may be single core or multicore, and the programs executed thereon may be configured for parallel or distributed processing. Logic subsystem 118 may optionally include individual components that are distributed throughout two or more devices, which may be remotely located and/or configured for coordinated processing. One or more aspects of logic subsystem 118 may be virtualized and executed by remotely accessible networked computing devices configured in a cloud computing configuration.

Data-holding subsystem 120 may include one or more physical, non-transitory, devices configured to hold data and/or instructions executable by the logic subsystem to implement the herein described methods and processes. When such methods and processes are implemented, the state of data-holding subsystem 120 may be transformed (e.g., to hold different data).

Data-holding subsystem 120 may include removable media and/or built-in devices. Data-holding subsystem 120 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 120 may include devices with one or more of the following characteristics: volatile, nonvolatile, dynamic, static, read/write, read-only, random access, sequential access, location addressable, file addressable, and content addressable. In some embodiments, Logic subsystem 118 and data-holding subsystem 120 may be integrated into one or more common devices, such as an application specific integrated circuit or a system on a chip.

FIG. 1 also shows an aspect of the data-holding subsystem in the form of removable computer-readable storage media 130, which may be used to store and/or transfer data and/or instructions executable to implement the herein described methods and processes. Removable computer-readable storage media 130 may take the form of CDs, DVDs, HD-DVDs, Blu-Ray Discs, EEPROMs, and/or floppy disks, among others.

It is to be appreciated that a “service”, as used herein, may be an application program executable across multiple user sessions and available to one or more system components, programs, and/or other services. In some implementations, a service may run on a server responsive to a request from a client via client devices 106.

Client devices 106 may comprise any suitable types of devices, including but not limited to televisions, set-top boxes, smart phones, portable media players, desktop computers, laptop computers, notepad computers, etc. In some instances, a user, indicated by dashed-line box 122, may consume media content via multiple different client devices, as indicated by client 1 and client 2 inside of box 122. For example, a user may consume video content on a television, a laptop computer, a notepad computer, a mobile smart phone, a portable media player, a slate device, a desktop computer, and a handheld gaming device, and all of these devices may be linked to the user account information 112 stored on or otherwise accessible by media content server system 102.

In the present embodiment, client 1 is a computerized system such as an interactive entertainment system configured to provide television, movies, video games, and other such media content. Client 1 is depicted as including a display 128 (e.g. a television or monitor), a logic subsystem 126, and a data-holding subsystem 132. Logic subsystem 126 may be configured to execute instructions stored in data-holding subsystem 132 to perform various user requested functions, such as streaming or downloading of media content items, as well as obtaining and presenting advertising information. FIG. 1 also depicts removable computer-readable storage media 134, which may be used to store and/or transfer data, such as executable instructions. Removable computer-readable storage media may take the form of CDs, DVDs, HD-DVDs, Blu-Ray Discs, EEPROMs, and/or floppy disks, among others.

Display 128 may be used to present a visual representation of data held by data-holding subsystem 132. As the herein described methods and processes change the data held by the data-holding subsystem 132, and thus transform the state of the data-holding subsystem 132, the state of display 128 may likewise be transformed to visually represent changes in the underlying data. As such, display 128 may be viewed by a user in order to watch and interact with downloaded and/or streamed media content items and advertising information. Display 128 may include one or more display devices utilizing virtually any type of technology. Such display devices may be combined with logic subsystem 126 and/or data-holding subsystem 132 in a shared enclosure, or such display devices may be peripheral display devices.

As mentioned above, one or more users may interact with media content server system 102 in an authenticated session. FIG. 1 shows examples of a single user session 140 and a multi-user session 140. First, FIG. 1 illustrates user 1 participating in a multi-user session 150 with user 2. In this example, user 1 and user 2 both log onto media content server system 102 via client 1 in order to access media content 104.

Users 1 and 2 also have other client devices that the media content server associates with the users based upon the user account information 112. As shown in FIG. 1, client 2 is a mobile device 136 associated with user 1, and client 3 is a mobile device 138 associated with user 2. Each of mobile device 136 and mobile device 138 includes a display. Where users 1 and 2 are both logged into an authenticated session with media content server system 102 via client 1, media content server system 102 may also interact with these uses via client 2 and client 3 as companion devices to present advertising content on these devices. Further, different advertising content may be presented to each of these users based upon demographic, historical, user preferences, and other such information, as described in more detail below. Media content server system 102 may access user account information 112 to determine demographics, user-specific settings, and/or user history for each of user 1 and user 2.

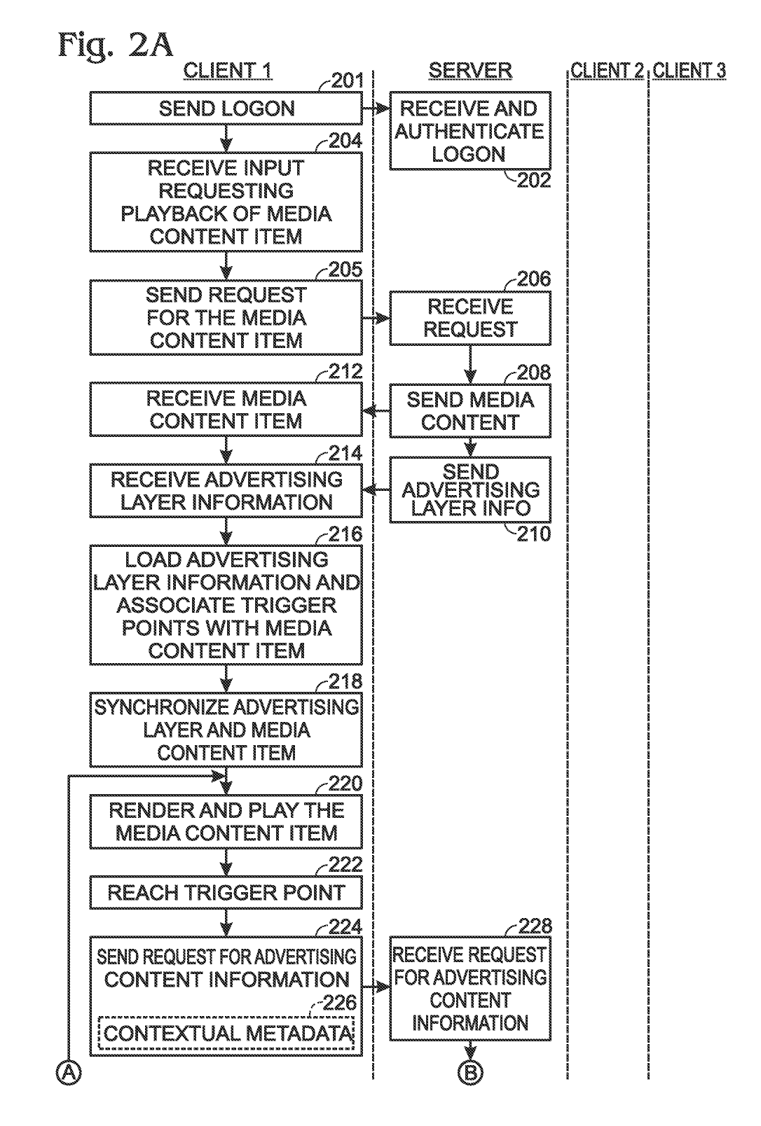

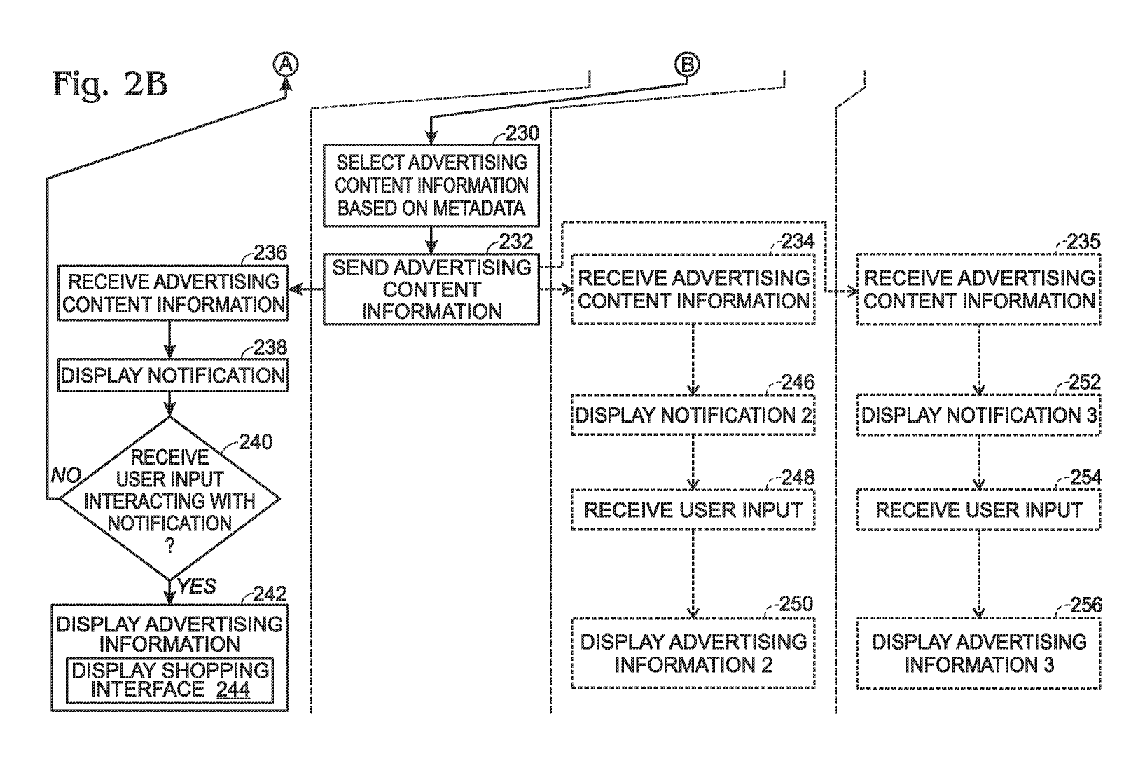

FIGS. 2A and 2B show an embodiment of a method 200 of providing advertising content in a media consumption environment. Method 200 is depicted in the context of the multi-user session shown in FIG. 1, but it will be understood that the concepts may be extended to a single client/single user session, or to any other suitable user session involving any suitable number of clients and/or users. First, at 201, logon requests for user 1 (who is associated with client 1 and client 2) and user 2 (who is associated with client 3) are sent from client 1. In this example, client 1 may be an interactive entertainment system such as a video game console, and clients 2 and 3 may be mobile devices. The media content server receives and verifies the request to log on user 1, as shown at 202. Next, at 204, client 1 receives a user input from either of user 1 or user 2 requesting playback of a media content item, such as a video. The media content server receives the request at 206, and sends the requested media content item to client 1 at 208. The media content server additionally sends advertising layer information corresponding to the requested media content item at 210.

Client 1 receives the media content item and the advertising layer information at 212 and 214, respectively. In 216, client 1 loads the advertising layer information, including associated trigger points with the requested media content item, into the advertising layer. Either before or at this time, client 1 also loads the media content item into a media player associated with the advertising layer. The advertising layer information and the requested media content item are next synchronized, at 218. The advertising layer information and the requested media content item are time-synched such that the advertising layer is contextually relevant to what is playing back at any instance of time. For example, if a requested video includes an actor wearing a specific type a shoe, an advertisement for the shoe may be triggered at the time it can be viewed in the video.

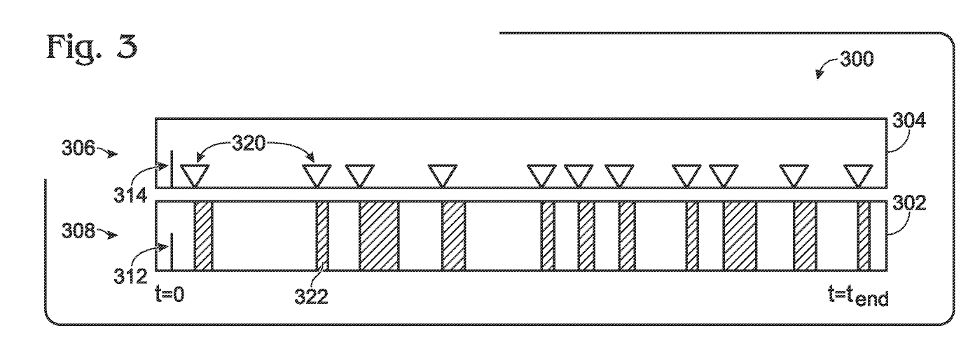

An example embodiment of a media content item playback timeline 300 is schematically depicted in FIG. 3, which shows a media content item timeline 302 and an advertising layer timeline 304. In this example embodiment, advertising layer information 306 is synchronized with media content item 308 via sync points 312 and 314 located respectively in media content item 308 and advertising layer information 306. Advertising layer information 306 includes a plurality of trigger points 320, wherein each trigger point corresponds to an event 322, such as the appearance of a specific object or action in the media content item 308. The width of each event 322 signifies how long the object represented by the event appears in the media content item 308. When the media content item 308 is played, play begins at time 0 (t=0) and ends after the duration of the media content item 308 (t=t_{end}). The trigger points 320 occur at specified intermediate time points.

Each of the plurality of trigger points 320 triggers the advertising layer to contact the advertising server to obtain updated advertising information. Further, each trigger point may comprise intra-media metadata that is send to the media content server when requesting advertising content. Such intra-media metadata may describe any suitable characteristic or characteristics of an intra-media object. For example, where an intra-media object is a consumer item, the intra-media metadata may include an identity, manufacturer, retailer, etc. of the consumer item. The intra-media metadata may be compiled and associated with the trigger points in any suitable manner, including manually and/or automatically via facial/object recognition techniques.

Various metadata items may be sent to the advertising server along with the request for advertising content. Examples of such metadata may include, but are not limited to, metadata that describes the media content item, intra-media metadata associated with a trigger point that describes objects presented in the media content item, time of day, time of year (e.g. upcoming holidays, season, etc.), the type of device on which advertising playback will occur, and the like. Further, such metadata also may include an identity/gender/age/geographic location/etc. of the users currently logged into the system. It will be understood that some metadata (e.g. user account info such as age, gender, hobbies/interest, past consumption history, as well as temporal information such as time of day, time of year) also may be accessed directly on the server system, rather than being sent by the client.

The metadata sent to the media content server, and/or metadata stored remotely on the server, may be used by the media content server to locate context-specific advertising. For example, a different advertisement may be shown at a same trigger point depending upon the time of year the media content item is consumed (e.g. during summer or near Christmas) on the age/gender/media consumption history/advertisement interaction history of the user(s), consuming the media content item, geographic location of the users, or based upon any other suitable metadata.

Returning again to FIG. 2A, at 220, client 1 renders and plays the media content item. As the media content item reaches a trigger point, at 222, client 1 sends a request to the server for the advertising content.

Referring next to FIG. 2B, at 230, advertising content is selected by the server based on metadata 226, and sent to client devices by the media content server at 232. The advertising content may be selected in any suitable manner. For example, in some situations, a paid sponsor may wish to insert an advertisement specific to a product shown in a media content item that is made by the sponsor. In this case, when triggered, advertising content provided by the sponsor may be provided. In some cases, a sponsor may provide different versions of a desired advertisement to be selected based upon user demographic information or other contextual metadata.

As another example, in some embodiments, advertisers may be permitted to bid on keywords that are, for example, related to advertiser's products. Then, when a call is made to the advertising content server at a trigger point, the advertising content may be selected based upon the bids submitted by the advertisers. As a more specific example, an advertisement of a highest bidder may be selected more frequently than an advertisement of a next-highest bidder. It will be understood that these examples of methods of selecting advertisements are provided for the purpose of example, and are not intended to be limiting in any manner.

Continuing with FIG. 2B, after selecting the advertising content, the media content server sends the advertising content information to client 1 at 236. Additionally or alternatively, in some instances, a trigger on client 1 may cause advertising content to be sent to client 2 (at 234), and/or client 3 (at 235). In this instance, client 2 and/or client 3 act as companion devices to client device 1, in that they are used to present an ancillary advertising experience related to the primary media content item playback experience provided by client 1. It will be understood that different advertisements may be sent to each client device, for example, based upon user demographic information, device type, as well as other factors mentioned above.

Upon receiving the advertising content, the client or clients that receive the advertising content next display a notification to a user that advertising content is available. For example, in the case of a media content item being displayed on a television or monitor, the notification at 238 may be displayed in such a manner as to be noticeable but not to detract from the primary experience of the media content item. Where the notification is displayed on a companion device such as client 2 (at 246) and/or client 3 (at 252), the notification may be more prominent, as it does not share screen space with the primary experience and is being displayed on a smaller screen. It will be understood that the notification may take any suitable form. For example, the notification may display a portion of the advertising content, a smaller version of the advertising content, or may take the form of a generic notification.

The notification may be displayed for any suitable duration, including but not limited to a duration of the appearance of a corresponding object in the media content item. If a user chooses not to interact with an advertising notification during this duration, the advertising notification will disappear from the display, as the method returns to 220 of FIG. 2A. Alternatively, if a user chooses to interact with the advertising notifications, then method 200 comprises receiving a user input interacting with the corresponding display advertising notifications, as indicated at 240 for client 1, at 248 for client 2, and at 254 for client 3. In this case, the client that received the input may display advertising content information, as indicated at 242, 250, and 256, respectively for clients 1, 2 and 3.

In some embodiments, the advertising information displayed may be configured to allow a user to purchase an item by interacting with the advertisement. Thus, method 200 may comprise displaying a shopping interface at 242. In such a case, the media content server may send additional advertising content as a user browses through shopping catalog pages displayed in shopping interface 242, may receive an order for an item from a client device, and also may receive an input of a payment. Payment may be received in any suitable manner, for example, in prepaid points, via credit or debit cards, via a line of credit with the company operating the media server, etc. It will be understood that a user may interact with the displayed advertising content in any suitable manner, including but not limited to via a touch screen input, a cursor control device, motions detected via a natural user interface such as a depth-sensing camera, voice commands using a microphone or microphone array, or in any other suitable manner.

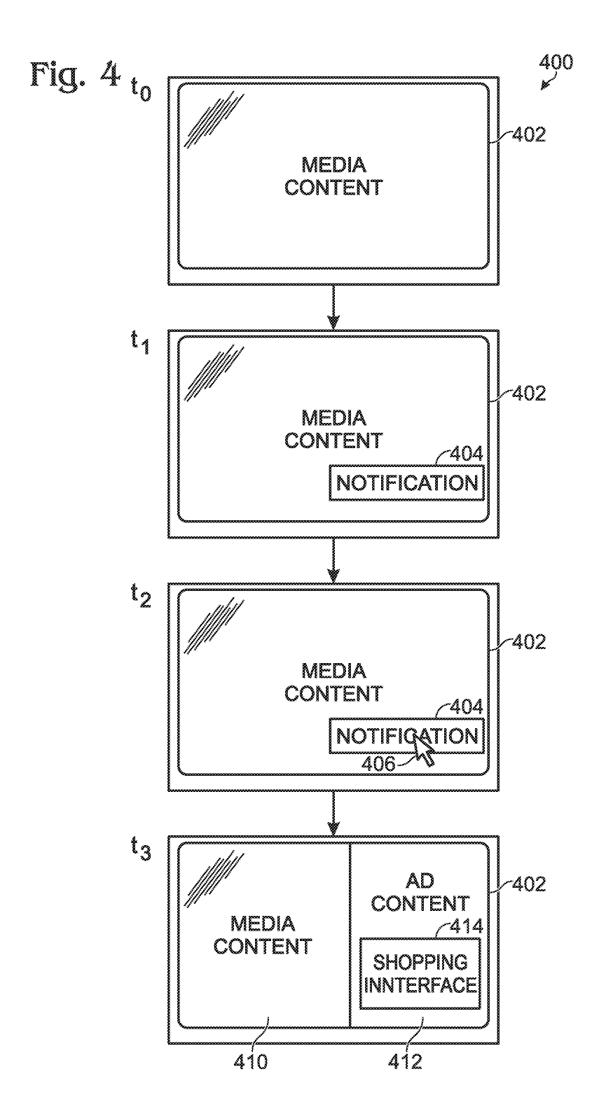

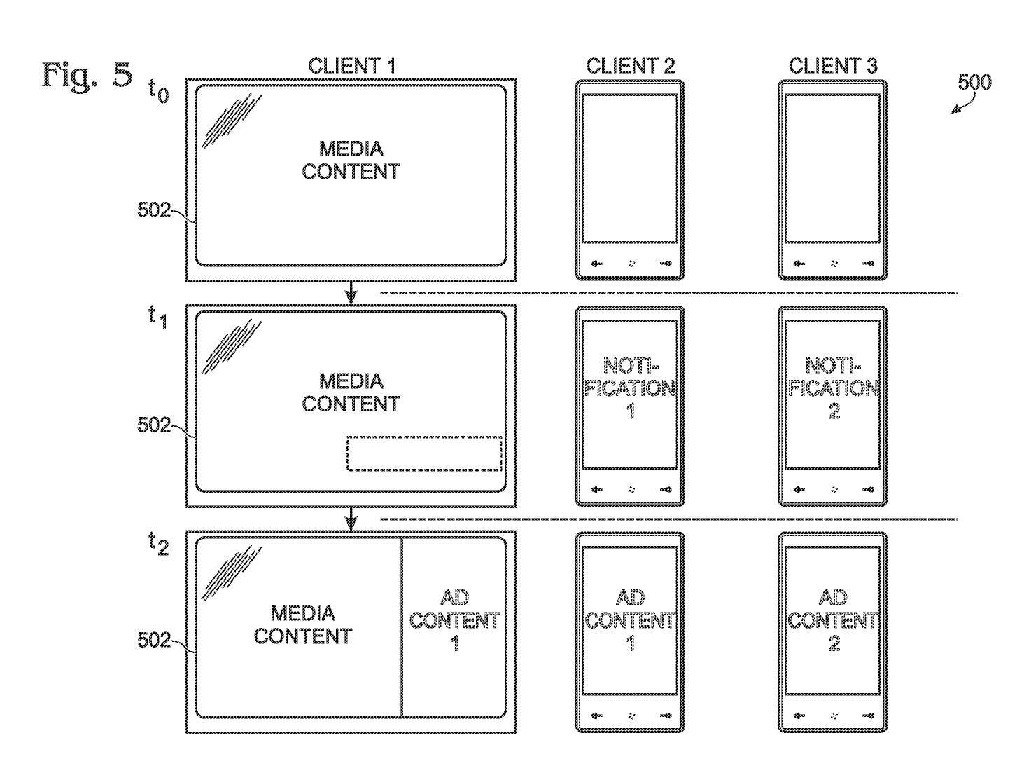

FIGS. 4 and 5 illustrate various embodiments of providing advertising content for media content, as described above. First, FIG. 4 shows a client device 400 such as a television or computer monitor. At t₀, the client device 400 is illustrated as showing media content 104 on a display screen 402 during media playback.

At t₁, an advertising layer trigger is reached, thereby triggering the request for and receipt of advertising information, and also triggering the display of an advertising notification 404 on the display screen. The advertising notification 404 is illustrated in the depicted embodiment as being located in the lower right-hand corner of the display screen 402. In other embodiments, the advertising notification may appear in any other suitable area of the screen. In some embodiments, the advertising notification may appear to slide into the screen from the bottom of the screen as a “toast”, or may fade in.

Next, at t₂, the advertising notification 404 is selected by a user. In the depicted embodiment, this is shown as a user interacting with the advertising notification 404 via a cursor 406. In other embodiments wherein display screen 402 is a touch screen, the advertising notification 404 may be selected by touch. Further, if the client device 400 is a mobile device, the advertising notification may be selected by an integral control button of the device, for example.

Next, at t₃, upon selection of the advertising notification, display screen 402 shows two regions including a media content play area 410 and an advertising content area 412 including a shopping interface 414 with which the user may interact.

FIG. 5 shows depicts an example of a multi-user, multi client session 500 including client 1, client 2, and client 3, wherein client 1 is a television or monitor, and clients 2 and 3 are mobile devices of two users logged into client 1. At tₒ, client 1 displays media content on a display screen 502 as a primary playback experience. It is noted that client 2 and client 3 do not display the media content. Next, at t₁, a trigger point is reached, triggering the request for and receipt of advertising information, and also the display of an advertising notification.

As mentioned above, in the multi-client, multi-user environment, notifications and advertising content may be displayed in any of a number of ways to users. For example, as shown in FIG. 5, a notification may be displayed on the client device that is playing the media content item (client 1 in FIG. 5), as shown by the dashed line rectangle 504 in the lower right-hand corner of the display screen 502 of client 1. Additionally or alternatively, notifications may be displayed on the companion devices. In the depicted embodiment, notification 1 and notification 2 displayed on clients 2 and 3 respectively may be the same notification, or may be different notifications for different advertising content.

Next, when a user interacts with a notification, advertising content is displayed. In the multi-client, multi-user environment, advertising content may be displayed in any of a number of ways. For example, if a user interacts with a notification displayed on the primary experience client (client 1 in FIG. 5), advertising content may be displayed on any of client 1, client 2 and client 3. Moreover, different advertising information may be displayed on different clients. Likewise, where one user interacts with a notification on a companion client, such as client 2, while another does not, such as client 3, then advertising content may be displayed on client 2 but not client 3.

In this manner, contextually relevant advertising may be presented during playback of a media content item without disturbing playback of the media content item. It will be appreciated that the advertising layer may be configured to be controllable by a user such that a user can elect to turn off the display of notifications and advertising content. It is to be further understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device comprising a media player and an advertising layer configured to display advertising information related to media played via the media player, a method of presenting advertising content for media, the method comprising:
receiving an input requesting playback of a media content item;
sending a request for the media content item to a media server;
receiving the media content item from the media server;
receiving advertising layer information from the media server;
associating trigger points in the advertising layer information with the media content item;
playing the media content item; and
upon reaching a selected trigger point during playback of the media content item, triggering display of a notification to notify the user of available advertising content.

2. The method of claim 1, wherein triggering display of a notification comprises sending a request to the media server for advertising content information and receiving the advertising content information.

3. The method of claim 2, further comprising displaying the notification, receiving an input interacting with the notification, and in response to the user input, displaying advertising content.

4. The method of claim 3, wherein the notification and the advertising content are displayed on a same display as the media content item.

5. The method of claim 3, wherein one or more of the notification and the advertising content is displayed on a different display than the media content item.

6. The method of claim 5, wherein one or more of the notification and the advertising content is displayed on a mobile device, and wherein the media content item is displayed on a television.

7. The method of claim 5, wherein the advertising content comprises a shopping interface configured to allow a user to purchase an item corresponding to an object displayed during playback of the media content item.

8. The method of claim 2, wherein sending the request for advertising content information comprises sending intra-media metadata related to an object in the media content item.

9. The method of claim 8, wherein the media content item is a video content item, and wherein the object in the media content item comprises a consumer item displayed in the video content item.

10. The method of claim 2, further comprising displaying the notification for a predetermined period of time, and if no user interaction with the notification is received during the predetermined period of time, then ceasing display of the notification.

11. The method of claim 1, wherein the selected trigger point is a first trigger point, wherein the notification is a first notification, and wherein the available advertising content is related to an intra-media object present in the media content item at the first trigger point, and further comprising:
upon reaching a second trigger point, triggering display of a second notification related to an intra-media object present in the media content item at the second trigger point.

12. A computer-readable storage medium comprising instructions stored thereon that are executable by a computing device to perform a method of presenting advertising content via an advertising layer for a media player, the method comprising:
receiving an input requesting playback of a media content item;
sending a request for the media content item to a media server;
receiving the media content item from the media server;
receiving advertising layer information from the media server;
associating trigger points in the advertising layer information with the media content item;
rendering and playing the media content item; and
upon reaching a selected trigger point during playback of the media content item,
sending a request to the media server for advertising content information associated with the selected trigger point, the request comprising contextual metadata;
receiving the advertising content information; and
displaying a notification configured to notify a user of available advertising content, the notification comprising a portion of the advertising content information.

13. The computer-readable storage medium of claim 12, wherein the contextual metadata comprises metadata regarding an intra-media object in the media content item.

14. The computer-readable storage medium of claim 12, wherein the method further comprises receiving a user input interacting with the notification, and in response to the user input, displaying advertising content.

15. The computer-readable storage medium of claim 14, wherein displaying advertising content comprises displaying a shopping interface configured to allow a user to purchase an item corresponding to an object displayed during playback of the media content item

16. A media server system configured to provide media content and advertising layer information to client devices, the media server comprising:
a logic subsystem; and
a data-holding subsystem comprising instructions stored thereon that are executable by the logic subsystem to
receive from a client device a request for a media content item;
send the media content item to the client device;
send advertising layer information to the client device, the advertising layer information comprising one or more trigger points each corresponding to an intra-media object in the media content item;
receive a request from the client device for advertising content information corresponding to a selected trigger point in the advertising layer information, the request comprising metadata related to a selected intra-media object;
select advertising content based upon the metadata related to the selected intra-media object; and
send the advertising content.

17. The media server system of claim 16, wherein the instructions are executable to send the advertising content to the client device.

18. The media server system of claim 16, wherein the client device is a first client device, and wherein the instructions are executable to send the advertising content to a second client device associated with a current user of the first client device.

19. The media server system of claim 16 wherein the instructions are executable to send different advertising content information to a third client device associated with another current user of the first client device in a multiple user session.

20. The media server system of claim 16, wherein the instructions are executable to select the advertising content based also upon one or more of an identity of a currently active user, a current time, a current date, and a bid received for a selected keyword corresponding to the metadata related to the selected intra-media object.
